(19) United States
(12) Patent Application Publication
(10) Pub. No.: US 2013/0231001 A1
(43) Pub. Date: Sep. 5, 2013

(54) MEMORY CARD SOCKET AND HARD CAM FOR SAME

(71) Applicant: Sung-Hyuk Joo, Ansan (KR)

(72) Inventor: Sung-Hyuk Joo, Ansan (KR)

(73) Assignee: MOLEX INCORPORATED, Lisle, IL (US)

(21) Appl. No.: 13/820,549

(22) PCT Filed: Sep. 2, 2011
(86) PCT No.: PCT/KR11/06529

§ 371 Date: May 9, 2013

(30) Foreign Application Priority Data
Sep. 2, 2010 (KR) 10-2010-0085857

(51) Int. Cl. H01R 13/629

(52) U.S. Cl. CPC H01R 13/62905
USPC 439/345

(57) ABSTRACT

The memory card socket of the Present Disclosure can achieve a microminiaturized and ultraslim configuration of a memory card/micro SIM card socket, in regard to the formation of the movement zones having step differences in the guide groove in order to ensure movement of the end of the pin rod along the guide groove, wherein a heart-shaped guide groove is formed within the heart cam and the end of the pin rod is inserted into the guide groove, by reducing the total thickness of the heart cam, through a reduction in the number of step differences of the zones from at least three to one, and replacement of the eliminated step differences with sloped protrusions.

### REFERENCE To RELATED APPLICATIONS

The Present Disclosure is a United States National Phase Application of PCT Patent Application No. PCT/KR2011/0006529, entitled “Memory Card Socket And Heart Cam For That Memory Card Socket,” filed on 2 Sep. 2011 with the Korean Intellectual Property Office (KIPO). Further, the Present Disclosure claims priority to prior-filed Korean Patent Application No. 10-2010-0085857, entitled “Memory Card Socket And Heart Cam For That Memory Card Socket,” filed on 2 Sep. 2010 also with the KIPO. The content of the aforementioned Patent Application is incorporated in its entirety herein.

### BACKGROUND OF THE PRESENT DISCLOSURE

The Present Disclosure relates, generally, to a heart cam configured to realize a push/push mechanism for a memory card socket, and ultimately to a memory card socket having push/push functionality for memory cards, micro SIM cards, etc. More specifically, the Present Disclosure enables the microminiaturization and ultraslim configuration of the heart cam by means of improved structure of the step differences that are formed within the guide groove of the cam.

Integrated Circuit (IC) cards in general come in several forms, including Subscriber Identification Module (SIM) cards, multimedia cards, smart media cards and memory stick cards. Of these types of IC cards, SIM cards are a chip-type card on which user information is recorded including the telephone number for use of a mobile phone in areas using GSM mobile telephony (various countries of Europe and Asia). It is also mounted in CDMA mobile telephones and used for functionality such as phone banking

With the slimming of mobile phones, etc., there has been a gradual concomitant trend toward thinner sockets that enable memory card insertion and removal. Referring to FIGS. 1-2, a conventional memory card socket is furnished with: an insulative housing 10 wherein the card 1 is mounted; a metal shell 20 that guides the insertion of the card 1 by coupling with the housing 10 while maintaining a specific interval from the housing 10; a plurality of contact terminals 30 that are supported on the housing 10, with one end part contacting the connection terminal (not shown) of the card 1, and the other end part being fixed to the printed circuit board (not shown); and a locking part 40 installed on the side of the housing 10 so as to selectively fix the insertion location of the card 1.

The locking part 40 is installed so as to enable sliding movement together with the card 1 within the housing 10. Further, it is furnished with: a heart cam 41 having a heart-shaped guide groove 41a; a pin rod 43, the near end 43a whereof is fixed to the housing 10 while the far end 43b is inserted into the guide groove 41a so as to move along the guide groove 41a while also fixing the position of the card 1; and a spring 45 that elastically supports the heart cam 41. The guide groove 41a is divided into zone A→zone B→zone C→zone D→zone E→zone F→zone G→zone H, and is configured so that the far end 43b of the pin rod 43 moves sequentially through zone A→zone B→zone C→zone D→zone E→zone F→zone G→zone H, of the guide groove 41a, in a process wherein after the card 1 is inserted into the housing 10, by pushing once the card 1 is locked, and if it is pushed once more, the card 1 is unlocked.

As shown in FIG. 3, based on height, the zone C is the highest, followed by zone D and zone H, followed by zone A and zone E, and zone F is the lowest. The reason for each the zone being thus separated by a step difference height step difference) is in order to prevent reverse motion of the far end 43b of the pin rod 43 within the guide groove 41a during the process of locking and unlocking the card 1, and maintain the smooth locking and unlocking action of the card by enabling motion through zone A→zone B→zone C→zone D→zone E→zone F→zone G→zone H; i.e., forward.

However, in the case of conventional memory card sockets, because at least one or more step differences must be formed in forming zone A through zone H within the guide groove of the heart cam, there are limits to the extent to which the thickness, t, of the heart cam itself can be reduced, and consequently there are substantial technical obstacles to achieving a microminiaturized and ultraslim configuration of the memory card socket.

### SUMMARY OF THE PRESENT DISCLOSURE

In order to resolve the above-described problems, the Present Disclosure has as an objective, providing a memory card socket that can achieve a microminiaturized and ultraslim configuration, in regard to the formation of the movement zones having step differences in the guide groove in order to ensure movement of the end of the pin rod along the guide groove, wherein a heart-shaped guide groove is formed within the heart cam and the end of the pin rod is inserted into the guide groove, by reducing the total thickness of the heart cam, through a reduction in the step differences of the zones from at least three to one, and replacement of the eliminated step differences with sloped protrusions.

To achieve the above-described objective, the memory card socket of the Present Disclosure is furnished with: an insulative housing wherein the memory card is mounted; a metal shell that guides the insertion of the memory card by coupling with the housing while maintaining a specific interval from the housing; a plurality of contact terminals supported on the housing, with one end part contacting the connection terminal of the memory card, and the other end part being fixed to the printed circuit board; a memory card recognition terminal that is supported on the housing so as to recognize the insertion of the memory card; and a locking unit supported on the housing and installed on the side of the housing so as to selectively fix the insertion position of the memory card. The locking unit is furnished with: a heart cam having a heart-shaped guide groove and installed so as to enable sliding motion together with the memory card within the side of the housing; a pin rod, the end whereof is inserted into the guide groove, that fixes the position of the memory card while also moving along the guide groove; and a spring that elastically supports the heart cam. The guide groove is divided into zone A→zone B→zone C→zone D→zone E→zone F→zone G→zone H, and is configured so that, in the process wherein after the memory card is inserted into the housing, a push locks the memory card and a subsequent push unlocks the memory card, the far end of the pin rod moves forward through zone A→zone B→zone C→zone D→zone E→zone F→zone G→zone H of the guide groove. The D zone, E zone and F zone are formed at the same height and relatively lower than the C zone. A first sloped projection is formed between the D zone and the E zone, and a second sloped projection is formed between the E zone and the F zone, to reduce the thickness of the heart cam.

As described above, the Present Disclosure can achieve a microminiaturized and ultraslim configuration of a memory card and micro SIM card socket, in regard to the formation of the movement zones having step differences in the guide groove in order to ensure movement of the end of the pin rod along the guide groove, wherein a heart-shaped guide groove is formed within the heart cam and the end of the pin rod is inserted into the guide groove, by reducing the total thickness of the heart cam, through a reduction in the step differences of the zones from at least three to one, and replacement of the eliminated step differences with sloped protrusions.

### BRIEF DESCRIPTION OF THE FIGURES

The organization and manner of the structure and operation of the Present Disclosure, together with further objects and advantages thereof, may best be understood by reference to the following Detailed Description, taken in connection with the accompanying Figures, wherein like reference numerals identify like elements, and in which:

FIG. 1 is an exploded oblique view of a conventional Integrated Circuit card socket;

FIG. 2 is a top view of a conventional heart cam;

FIG. 3 is a cross-section illustrating the step differences of a conventional heart cam;

FIG. 4 is an exploded oblique view showing a memory card socket according to the Present Disclosure;

FIG. 5 is an assembled oblique view showing the memory card socket of FIG. 4;

FIG. 6 is a top view of the heart cam according to the Present Disclosure; and

FIG. 7 is a cross-section illustrating the step differences of the heart cam of FIG. 6.

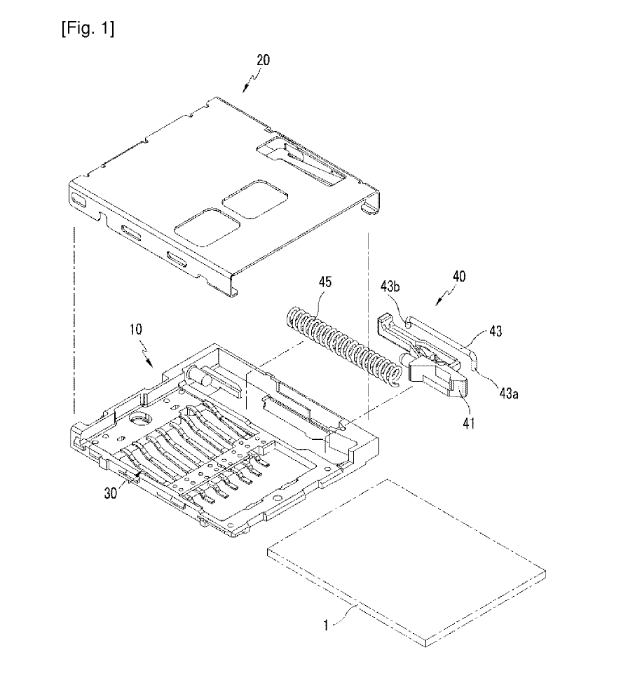

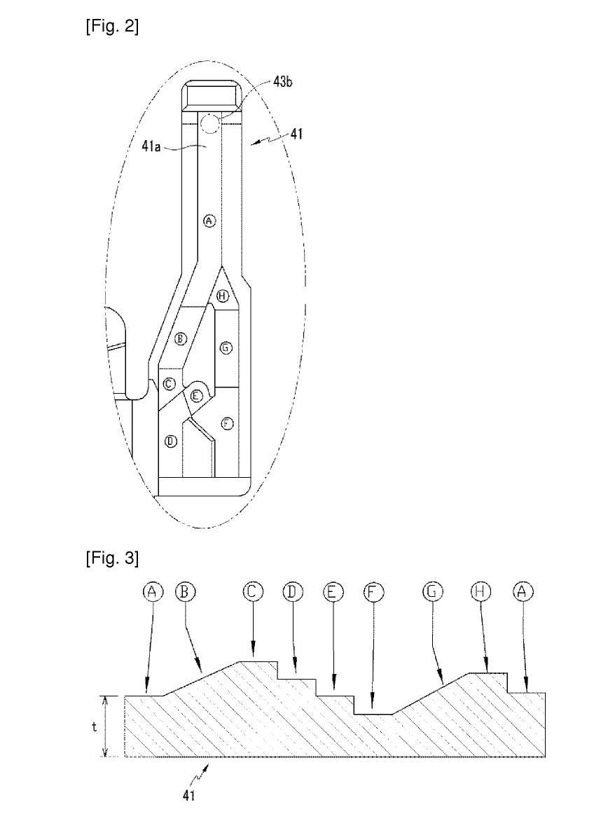

### DESCRIPTION OF THE PREFERRED EMBODIMENTS

While the Present Disclosure may be susceptible to embodiment in different forms, there is shown in the Figures, and will be described herein in detail, specific embodiments, with the understanding that the Present Disclosure is to be considered an exemplification of the principles of the Present Disclosure, and is not intended to limit the Present Disclosure to that as illustrated.

As such, references to a feature or aspect are intended to describe a feature or aspect of an example of the Present Disclosure, not to imply that every embodiment thereof must have the described feature or aspect. Furthermore, it should be noted that the description illustrates a number of features. While certain features have been combined together to illustrate potential system designs, those features may also be used in other combinations not expressly disclosed. Thus, the depicted combinations are not intended to be limiting, unless otherwise noted.

In the embodiments illustrated in the Figures, representations of directions such as up, down, left, right, front and rear, used for explaining the structure and movement of the various elements of the Present Disclosure, are not absolute, but relative. These representations are appropriate when the elements are in the position shown in the Figures. If the description of the position of the elements changes, however, these representations are to be changed accordingly.

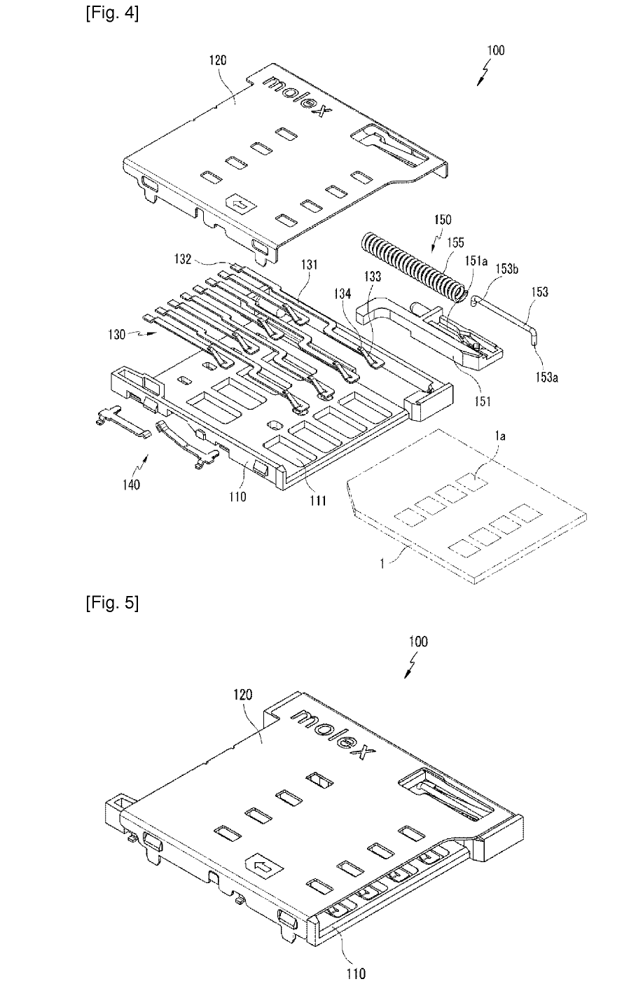

Referring to FIGS. 4-5, the memory card socket 100 of the Present Disclosure is furnished with: an insulative housing 110 wherein the memory card 1 is mounted; a metal shell 120 that guides the insertion of the memory card 1 by coupling with the housing 110 while maintaining a specific interval from the housing 110; a plurality of contact terminals 130 that are supported on the housing 110, with one end part contacting the connection terminal 1a of the memory card 1, and the other end part being fixed to the printed circuit board (not shown); a memory card recognition part 140 that is supported on the housing 110 so as to recognize the insertion of the memory card 1; and a locking unit 150 that is installed on the side of the housing 110 so as to selectively fix the insertion position of the memory card 1.

The housing 110 comprises an insulator, such as a conventional plastic. On the bottom surface, a plurality of grooves 111 are formed to prevent interference with the connection terminals 1a in the event of elastic deformation of the connection terminals 1a. The metal shell 120 is formed of a conventional metal material that guides the insertion of the memory card 1.

The contact terminal 130 is intended to connect electrically with the memory card 1 and printed circuit board 8. Contact terminals 130 are positioned in sequence, and 4 tensioned sloping parts 133, described below, are deployed to the front and back.

The locking unit 150 is furnished with: a heart cam 151 having a heart-shaped guide groove 151a and installed so as to enable sliding motion together with the memory card 1 within the side of the housing 110; a pin rod 153, the end whereof is inserted into the guide groove 151a, that fixes the position of the memory card 1 while also moving along the guide groove 151a; and a spring 155 that elastically supports the heart cam 151.

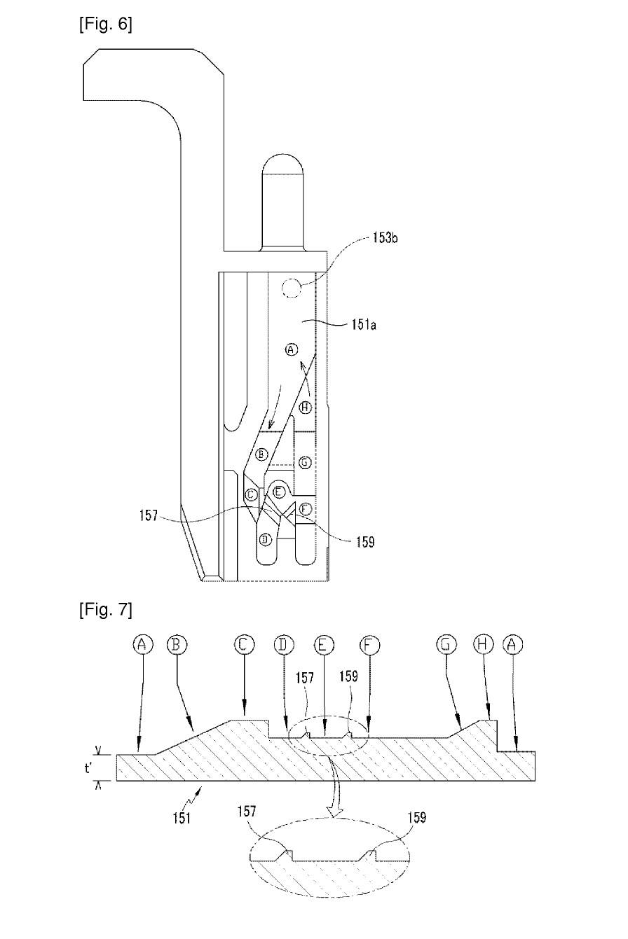

The heart cam 151 according to the Present Disclosure is furnished with a guide groove 151a, and referring to FIG. 6, the guide groove 151a is divided into zone A→zone B→zone C→zone D→zone E→zone F→zone G→zone H. It is configured so that, in the process wherein after the memory card 1 is inserted into the housing 110, a push locks the memory card 1 and a subsequent push unlocks the memory card 1, the far end 153b of the pin rod 153 moves forward (in the direction of the arrow through zone A→zone B→zone C→zone D→zone E→zone F→zone G→zone H of the guide groove 151a).

Note that the step difference between the respective zones of the guide groove 151a of the heart cam 151 is meant to ensure smooth locking and unlocking action by ensuring that the far end 153b of the pin rod 153 moves forward and not backward within the guide groove 151a in the process of locking and unlocking the memory card 1. Here “step difference” refers to the difference in height between the respective zones. The Present Disclosure is characterized by the reduction in the step differences from a minimum of three to one, and the enabling of microminiature and ultraslim configuration by reducing the thickness, t′, of the heart cam 151, through the formation of a 1st and 2nd sloped projection 157, 159 which fill the role of step differences.

Referring to FIG. 7, in the heart cam 151 of the Present Disclosure, the A zone, the D zone, the E zone and the F zone are at the lowest level: the C zone and the H zone are at the highest level; and the B zone and the G zone are sloped surfaces connecting the highest level and the lowest level. Only one step difference is formed between the highest level and the lowest level.

Here, the D zone, the E zone, and the F zone are formed at the same height and lower than the C zone, and a first sloped projection 157 is formed between the D zone and the E zone, while a second sloped projection 159 is formed between the E zone and the F zone. The first sloped projection 157 and the 2nd sloped projection 159 function in the same way as step differences to enable motion of the end 153b of the pin rod 153 through the zone D→the zone E→the zone F.

In operation, the memory card 1 is pushed into the insulative housing 110 to insert it. The metal shell 120 then acts to guide the insertion of the memory card 1. The heart cam 151 is then supported elastically on the spring 155; the end of the pin rod 153 moves its position through zone A→zone B→zone C→zone D→zone E of the guide groove 151a, so that the memory card 1 shifts from the separation position (unlocking) to the insertion position (locking) In this process, the end 153b of the pin rod 153 moves over the 1st sloped projection 157 to move from the zone D to the zone E, and then remains caught in the zone E.

If the memory card 1 is pushed once more, the end 153b of the pin rod 153 is again moved through zone E→zone F→zone G→zone H→zone A of the guide groove 151a, so that the memory card 1 is again shifted back to separation position (unlocking). In this process, the end 153b of the pin rod 153 is blocked by the 1st sloped projection 157, so that it cannot move backward, and upon moving over the second sloped projection 159, it moves from the zone E to the zone F. After crossing over the sloped zone G, it reaches the zone F, which is at maximum height, and then moves to the zone A.

As described above, in regard to the formation of movement zones having step differences in the guide groove in order to ensure movement of the end of the pin rod along the guide groove, wherein a heart-shaped guide groove is formed within the heart cam and the end of the pin rod is inserted into the guide groove, the Present Disclosure can achieve a microminiaturized and ultraslim configuration of a memory card/SIM card socket by reducing the total thickness of the heart cam, through a reduction in the step differences between zones from at least three to one, and replacement of the eliminated step differences with sloped protrusions.

While a preferred embodiment of the Present Disclosure is shown and described, it is envisioned that those skilled in the art may devise various modifications without departing from the spirit and scope of the foregoing Description and the appended Claims.

What is claimed is:

1. A memory card socket furnished with:
an insulative housing wherein the memory card is mounted;
a metal shell that guides the insertion of the memory card by coupling with the housing while maintaining a specific interval from the housing;
a plurality of contact terminals that are supported on the housing, with one end part contacting the connection terminal of the memory card, and the other end part being fixed to the printed circuit board;
a memory card recognition part supported on the housing to recognize the insertion of the memory card; and
a locking unit installed on the side of the housing so as to selectively fix the insertion position of the memory card;
wherein the locking unit is furnished with:
a heart cam having a heart-shaped guide groove and installed so as to enable sliding motion together with the memory card within the side of the housing;
a pin rod, the near end whereof is fixed to the housing, and the far end whereof is inserted into the guide groove, fixing the position of the memory card while moving along the guide groove; and
a spring that elastically supports the heart cam;
wherein
the guide groove is divided into zone A→zone B→zone C→zone D→zone E→zone F→zone G→zone H, and is configured so that the far end of the pin rod moves sequentially through zone A→zone B→zone C→zone D→zone E→zone F→zone G→zone H, of the guide groove, in a process wherein after the card is inserted into the housing, by pushing once the card is locked, and if it is pushed once more, the card is unlocked; and
the D zone, the E zone and the F zone are at the same height and lower than the C zone, a first sloped projection is formed between the D zone and the E zone, and a second sloped projection is formed between the E zone and the F zone, so as to reduce the thickness, t′, of the heart cam.

2. The memory card socket of claim 1, wherein the A zone, the D zone, the E zone and the F zone are at the lowest level.

3. The memory card socket of claim 2, wherein the C zone and the H zone are at the highest level.

4. The memory card socket of claim 3, wherein the B zone and the G zone are sloped surfaces connecting the highest level and the lowest level.

5. The memory card socket of claim 4, wherein only one step difference is formed between the highest level and the lowest level.

6. The memory card socket of claim 5, wherein the first sloped projection and the second sloped projection function as step differences so as to enable the end of the pin rod to move from the zone D→the zone E→the zone F.

7. The memory card socket of claim 1, wherein the first sloped projection and the second sloped projection function as step differences so as to enable the end of the pin rod to move from the zone D→the zone E→the zone F.

8. A heart cam for a memory card socket, furnished with a heart-shaped guide groove, wherein the guide groove is divided into zone A→zone B→zone C→zone D→zone E→zone F→zone G→zone H, and is configured so that the end of the pin rod traverses zone A→zone B→zone C→zone D→zone E→zone F→zone G→zone H to lock and unlock the memory card to the housing.

9. The heart cam of claim 8, wherein the A zone, the D zone, the E zone and the F zone are at the lowest level.

10. The heart cam of claim 9, wherein the C zone and the H zone are at the highest level.

11. The heart cam of claim 10, wherein the B zone and the G zone are sloped surfaces connecting the highest level and the lowest level.

12. The heart cam of claim 11, wherein a first sloped projection is formed between the D zone and the E zone.

13. The heart cam of claim 12, wherein a second sloped projection is formed between the E zone and the F zone, thus enabling a reduction in total thickness, t′.

14. The heart cam of claim 8, wherein the first sloped projection and the second sloped projection function so as to enable the end of the pin rod to traverse the zone D→the zone E→the zone F.
